(19) United States
(12) Patent Application Publication
(10) Pub. No.: US 2011/0054572 A1
(43) Pub. Date: Mar. 3, 2011

(54) THERAPEUTIC ELECTROLYSIS DEVICE WITH REPLACEABLE IONIZER UNIT

(75) Inventors: David M. Jeffrey, Colorado Springs, CO (US); Neill E. Moroney, Aurora, CO (US)

(73) Assignee: A Major Difference, Inc., Aurora, CO (US)

(21) Appl. No.: 12/846,786

(22) Filed: Jul. 29, 2010

Related U.S. Application Data
(60) Provisional application No. 61/229,629, filed on Jul. 29, 2009.

(51) Int. Cl. A61H 33/00; B23P 6/00

(52) U.S. Cl. 607/85; 29/402.08

(57) ABSTRACT

A method for replacing an ionizer unit of a therapeutic spa system may include removing a fastener that joins a first plate of a frame assembly to a second plate of the frame assembly. The first plate may be spaced apart from and substantially parallel to the second plate when joined to the second plate by the fastener. The method may further include detaching the first plate and the second plate of the frame assembly from a first ionizer unit supported by the first and second plates, joining a second ionizer unit to the first and second plates, and rejoining the first and second plates with the fastener.

### CROSS-REFERENCE TO RELATED APPLICATIONS

This application claims the benefit under 35 U.S.C. §119(e) to U.S. Provisional Application No. 61/229,629, filed on Jul. 29, 2009 and entitled “Therapeutic Electrolysis Device with Replaceable Ionizer Unit,” which is hereby incorporated herein by reference in its entirety.

### FIELD

The present invention relates to electrolysis devices for use in connection with therapeutic purposes. In particular, the present invention relates to therapeutic electrolysis devices that include a replaceable ionizer unit.

### BACKGROUND

Electrolysis involves ionizing water by passing an electrical current through water. When water is ionized, the individual water molecules are split into their constituent elements, namely hydrogen ions (H+) and hydroxyl ions (OH−).

By creating a preponderance of either negative or positive ions in water, desirable effects may be realized. For example, charged particles may be drawn from the body by placing a body part, such as the feet, in a water bath having a preponderance of negative or positive ions. For example, metal cations may be attracted to alkaline water, or water in which a preponderance of negative ions has been produced. These metal cations may pass through the skin of a user and into the ionized water.

The ionizer unit may wear out or malfunction and require replacement. Generally, the ionizer unit in a conventional foot bath system is either fixedly secured to the foot bath, such as through rivets or welding, or otherwise secured using hardware that may be difficult to remove. Therefore, it may be difficult for a typical user, such as a home user or a therapeutic practitioner, to remove and replace an ionizer unit in a foot bath. To provide such maintenance, the user may be required to ship the foot bath system to a third party who performs the proper maintenance on the system. This may be both costly and inconvenient for the purchaser. Further, the purchase of a new ionic foot bath system may be cost prohibitive to some purchasers. Thus, what is needed is an ionic foot bath system that includes a conveniently replaceable ionizer unit.

### SUMMARY

One embodiment of the present invention may include a method for replacing an ionizer unit of a therapeutic spa system. The method may include removing a fastener that joins a first plate of a frame assembly to a second plate of the frame assembly. The first plate may be spaced apart from and substantially parallel to the second plate when joined to the second plate by the fastener. The method may also include detaching the first plate and the second plate of the frame assembly from a first ionizer unit supported by the first and second plates, joining a second ionizer unit to the first and second plates, and rejoining the first and second plates with the fastener.

In another embodiment of the method, the frame assembly may further include a third plate configured to be releasably joined to the first and the second plates. The first ionizer unit may be joined to the third plate, and the first and second plates of the frame assembly may be detached from the third plate before joining the second ionizer unit to the first and second plates. In a further embodiment, the frame assembly may further include a fourth plate supporting the first ionizer unit, and the first and second plates of the frame assembly may be detached from the fourth plate before joining the second ionizer unit to the first and second plates. Additionally, the method may also include detaching from the first ionizer unit an electrical connection joining the ionizer unit to a power supply.

One embodiment of the present invention may include a therapeutic spa system. The spa system may include a frame assembly comprising a first plate, a second plate and a third plate. The first plate of the frame assembly may be releasably secured to the second plate of the frame assembly by a fastener. The first plate may be spaced apart from and substantially parallel to the second plate when joined by the fastener, and the third plate may be positioned between the first and second plates. The spa system may also include an ionizer unit including an electrical terminal. The ionizer unit may be supported by the frame assembly and positioned between the first and the second plates, and at least a portion of the electrical terminal may extend through a slot defined in the third plate.

In another embodiment of the therapeutic spa system, the third plate may include portions configured for receipt within respective openings in the first and the second plates. Additionally, at least a portion of the ionizer unit may be secured to the third plate. The frame assembly may further include a fourth plate releasably secured to and supporting the ionizer unit. The fourth plate may include portions configured for insertion into respective openings in the first and second plates.

In another embodiment of the therapeutic spa system, the electrical terminal may include a prong configured for insertion into an electrical receptacle of a control unit. The spa system may further include a basin configured to hold a fluid and a control unit configured to be coupled to a power source, and the ionizer unit may be coupled to the control unit.

In a further embodiment of the therapeutic spa system, an ionizer unit may be supported by a frame assembly comprising a first plate, a second plate, and a third plate. The first plate may be spaced apart from the second plate and the third plate may extend between the first and second plates. The ionizer unit may include a first plate assembly formed from conductive material and a second plate assembly formed from conductive material. The first plate assembly may include a first terminal portion and the second plate assembly may include a second terminal portion. The first plate assembly may include a portion received within a first slot defined in the first plate of the frame assembly, and the second plate assembly may include a portion received within a second slot defined in the first plate of the frame assembly. The first terminal portion may be releasably fastened to the second plate of the frame assembly proximate an end portion of the first terminal portion and the second terminal portion may be releasably fastened to the second plate of the frame assembly proximate an end portion of the second terminal portion. The end portion of the first terminal portion may extend away from the second plate at an acute angle relative to the second plate.

In other embodiments of the therapeutic spa system, the third plate may include portions configured for receipt within respective openings in the first and second plates of the frame assembly. Additionally, the frame assembly may further include a fourth plate including portions configured for receipt within respective openings in the first and second plates of the frame assembly. In one embodiment, the end portion of the first terminal portion may include a prong configured for insertion into an electrical receptacle of a control unit. The therapeutic spa system may further include a basin configured to hold a fluid, and the control unit may be configured to be coupled to a power source.

### BRIEF DESCRIPTION OF THE DRAWINGS

FIG. 1 illustrates a perspective view of a therapeutic spa system.

FIG. 2 illustrates a block diagram of the therapeutic spa system shown in FIG. 1.

FIG. 3 illustrates a side elevation view of an ionizer unit supported in a frame assembly for the therapeutic spa system shown in FIG. 1.

FIG. 4 illustrates a front perspective view of the ionizer unit depicted in FIG. 3.

FIG. 5 illustrates an exploded front perspective view of the ionizer unit depicted in FIG. 3.

FIG. 6a illustrates a perspective view of an ionizer unit supported in a frame assembly.

FIG. 6b illustrates a partial exploded perspective view of the ionizer unit and frame assembly of FIG. 6a.

FIG. 7a illustrates a perspective view of an ionizer unit supported in a frame assembly.

FIG. 7b illustrates a partial exploded perspective view of the ionizer unit and frame assembly of FIG. 7a.

FIG. 8a illustrates a perspective view of an ionizer unit supported in a frame assembly.

FIG. 8b illustrates a partial exploded perspective view of the ionizer unit and frame assembly of FIG. 8a.

FIG. 9a illustrates a perspective view of an ionizer unit supported in a frame assembly.

FIG. 9b illustrates a partial exploded perspective view of the ionizer unit and frame assembly of FIG. 9a.

FIG. 10a illustrates a perspective view of an ionizer unit supported in a frame assembly.

FIG. 10b illustrates a partial exploded perspective view of the ionizer unit and frame assembly of FIG. 10a.

FIG. 11a illustrates a perspective view of an ionizer unit supported in a frame assembly.

FIG. 11b illustrates a partial exploded perspective view of the ionizer unit and frame assembly of FIG. 11a.

FIG. 12a illustrates a perspective view of an ionizer unit supported in a frame assembly.

FIG. 12b illustrates a partial exploded perspective view of the ionizer unit and frame assembly of FIG. 12a.

FIG. 12c illustrates a cross-sectional view of the ionizer unit and frame assembly of FIG. 12a, as taken along line 12d-12d, showing the end portion of the electrical terminal in a first compressed position.

FIG. 12d is a view similar to the view illustrated in FIG. 12c, showing the end portion of the electrical terminal in a second uncompressed position.

FIG. 13a illustrates a perspective view of an ionizer unit supported in a frame assembly.

FIG. 13b illustrates a partial exploded perspective view of the ionizer unit and frame assembly of FIG. 13a.

FIG. 14a illustrates an exploded perspective view of the ionizer unit and frame assembly shown in FIG. 6a.

FIG. 14b illustrates a partial exploded perspective view of an ionizer unit and frame assembly.

FIG. 15 illustrates a flow diagram of a method of replacing an ionizer unit in a therapeutic spa system.

FIG. 16a illustrates a perspective view of an ionizer unit and a frame assembly before the ionizer unit is removed.

FIG. 16b illustrates a perspective view of the ionizer unit and frame assembly shown in FIG. 16a with the fastener withdrawn from the frame assembly, but before the ionizer unit is removed.

FIG. 16c illustrates a perspective view of the frame assembly shown in FIG. 16a with the ionizer unit removed.

FIG. 16d illustrates a perspective view of the frame assembly shown in FIG. 16a and a replacement ionizer unit before the fastener is secured to the frame assembly.

FIG. 16e illustrates a perspective view of the replacement ionizer unit shown in FIG. 16d supported in the frame assembly shown in FIG. 16a.

### DETAILED DESCRIPTION

Described herein are therapeutic ionic apparatuses with replaceable ionizer units. These apparatuses may include a frame assembly supporting an ionizer unit that can be selectively disassembled and separated from the ionizer unit. The ionizer unit may include an electrical plate assembly that includes terminal end portions that are selectively joined to removable electrical receptacles. In some versions of the apparatus, the terminal end portions may be joined to a replacement plate that forms a portion of the ionizer unit. In such versions of the ionic bath apparatus, the terminal end portions may extend through openings defined in the plate. The replacement plate may, in turn, be removably joined to one or more other plates forming the frame assembly. Some ionic bath systems may include a basin or a tub holding water that is ionized using the ionizer unit, as well as a control unit coupled to the ionizer unit.

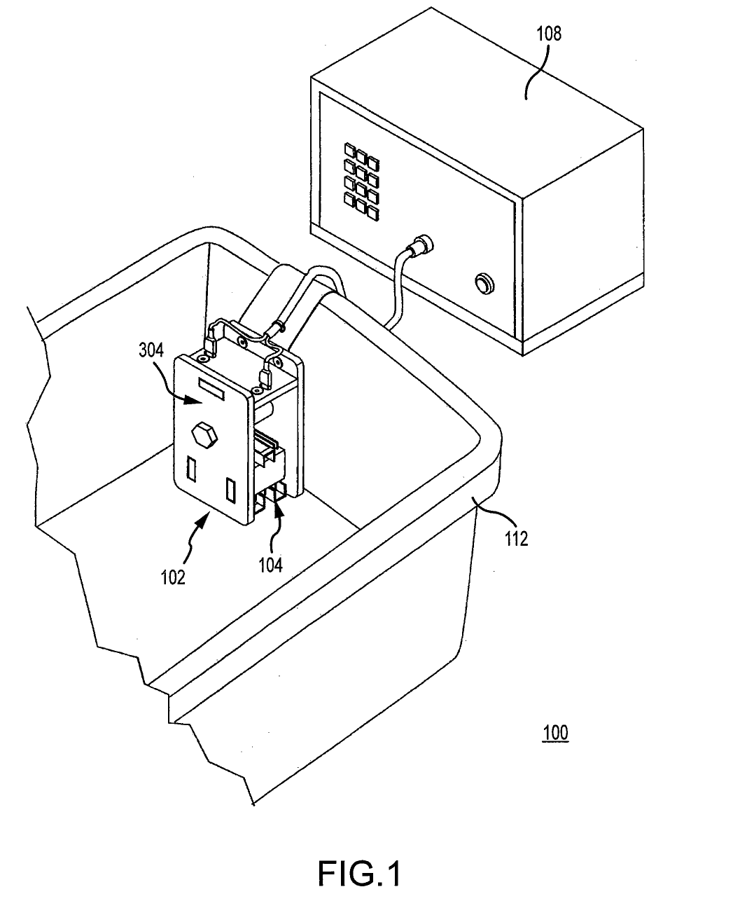

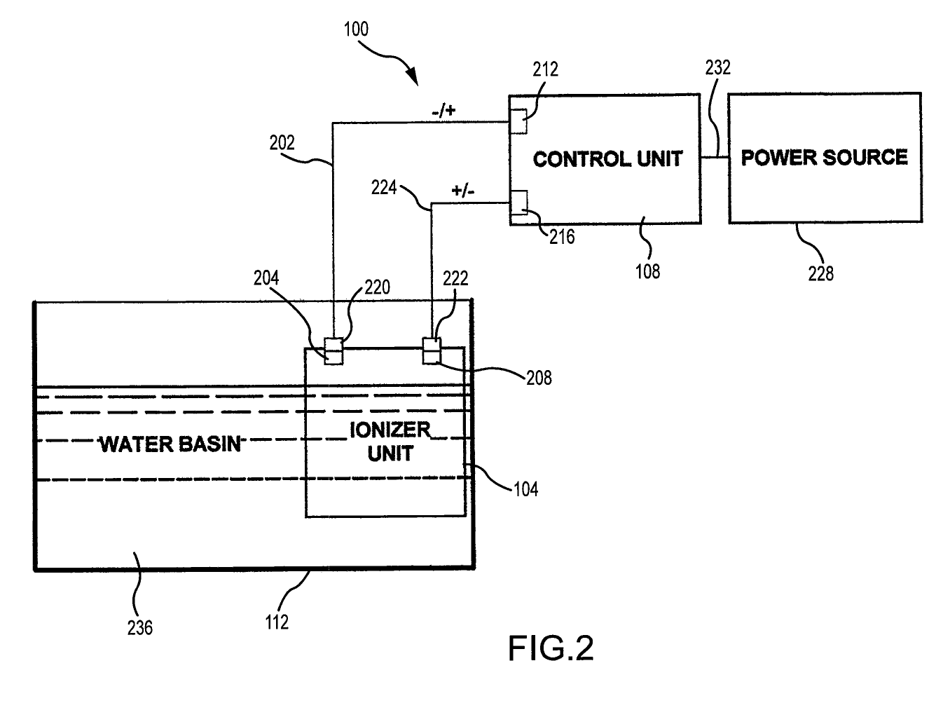

A therapeutic ionic bath system 100 is depicted in FIG. 1. In general, the therapeutic ionic bath system 100 may include a therapeutic ionic apparatus 102 interconnected to a control unit 108. The therapeutic ionic apparatus 102 may include an ionizer unit 104 joined removably to a frame assembly 304 and interconnected to a control unit 108. In addition, the therapeutic ionic bath system 100 may include a basin 112 for receiving water 236 (see FIG. 2) ionized by the ionizer unit 104. Furthermore, in operation, the therapeutic ionic bath system 100 may utilize water 236 (see FIG. 2) held in the basin 112.

FIG. 2 depicts a block diagram of the therapeutic ionic bath system 100. With reference to FIG. 2, the ionizer unit 104 may include a first male electrical prong 204 and a second male electrical prong 208. The first male electrical prong 204 may be interconnected to a first switchable electrical terminal 212 on the control unit 108 by a first electrical conductor or conduit 202. The first electrical conductor or conduit 202 may include a first female electrical receptacle 220 configured to receive the first electrical prong 204. Similarly, the second male electrical prong 208 of the ionizer unit 104 may be interconnected to a second switchable terminal 216 of the control unit 108 by a second electrical conductor or conduit 224. The second electrical conductor or conduit 224 may include a second female electrical receptacle 220 configured to receive the second electrical prong 208. The first electrical prong 204 and the second electrical prong 208 may be connected to separate conductor plates within the ionizer unit. In general, the polarity of the first 212 and second 216 switchable terminals of the control unit 108 may be selectively reversed. In one implementation, the control unit 108 may supply 24V DC at the switchable terminals 212, 216. However, the control unit 108 may be configured to operate at other voltages, use AC current, or some combination thereof. A power source 228 may provide electrical power to the control unit 108 over power supply cord 232. In accordance with one implementation, the power source 228 may be a line voltage source or any other suitable source of power.

The water basin 112 contains a quantity of water 236, such as ordinary tap water. The ionizer unit 104 may be partially submerged in the water 236. Operation of the ionizer unit 104 via the control unit 108 causes water in the water basin 112 to ionize, as described in more detail in U.S. Pat. No. 7,160,434, the entirety of which is incorporated by reference herein. By placing the feet, hands, or other body part of a user within the water basin 112 and powering the bath system, the user may experience a feeling of relaxation, as well as an enhanced feeling of well being.

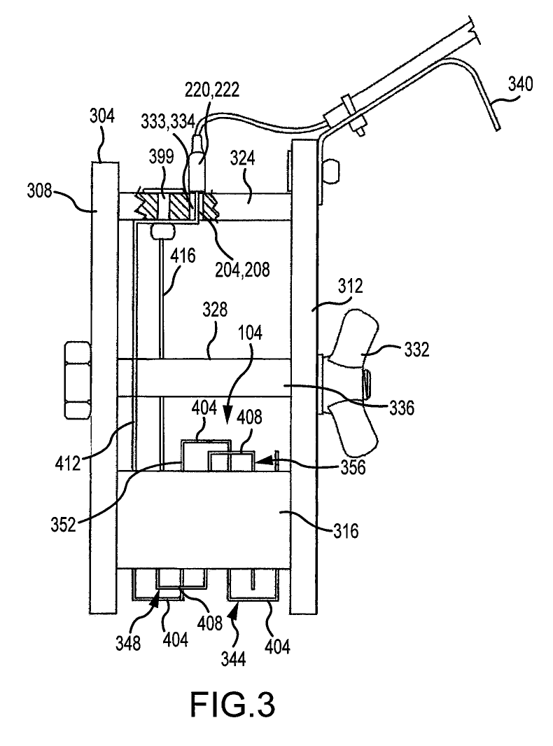

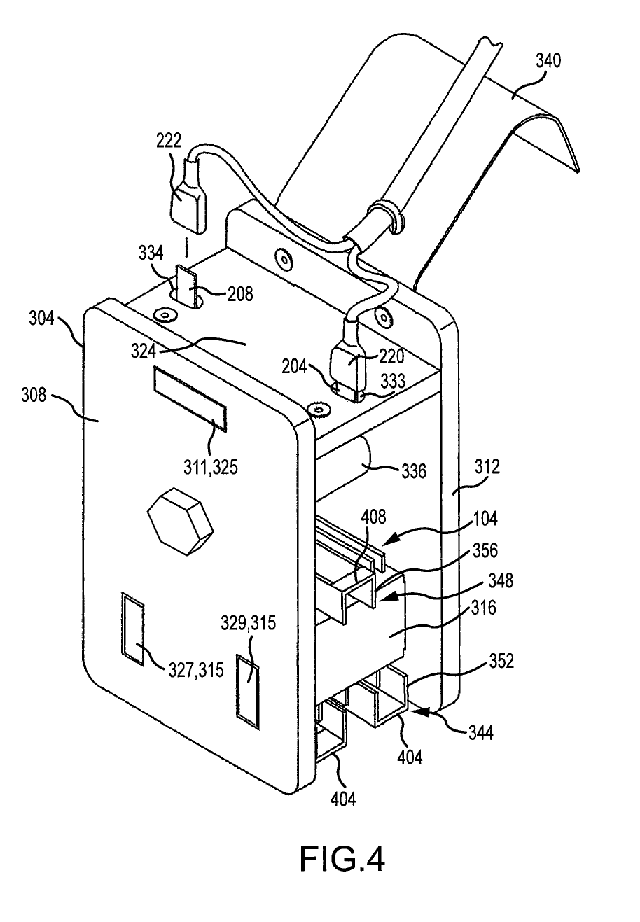

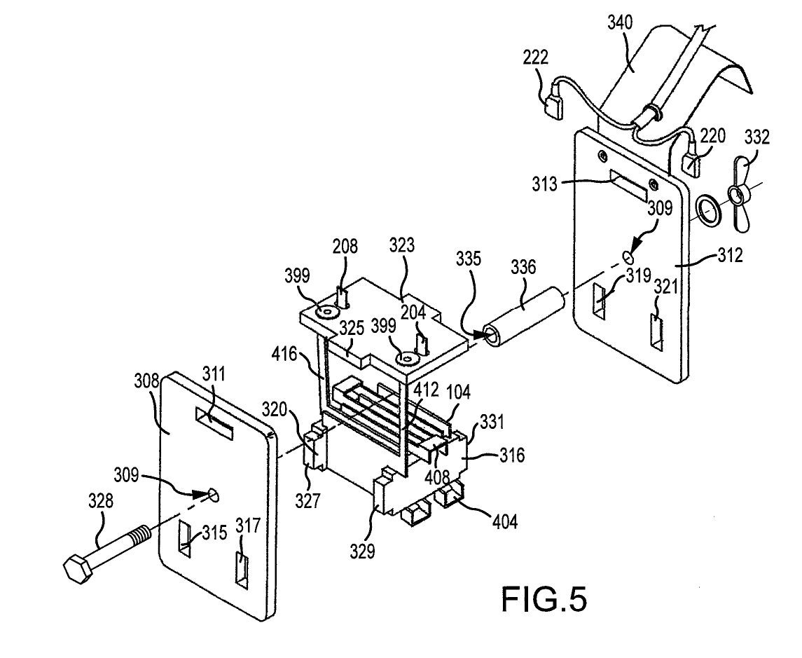

With reference now to FIGS. 3-5, the ionizer unit 104 and the frame assembly 304 are shown. In general, the ionizer unit 104 is supported in the frame assembly 304. The frame assembly 304 may include a front plate 308, a back plate 312, a pair of side plates 316, 320, and a top plate 324. The frame assembly 304 may be formed from a non-conductive material such as plastic or the like. The front 308 and back 312 plates may each include an opening 311, 313 or a groove configured to receive and hold the front and back protruding portions 325, 323 of the top plate 324. In addition, the front 308 and back 312 plates may also include additional openings 315-321 or grooves configured to receive and hold the front and back protruding portions 327-333 of the side plates 316, 320. As best illustrated in FIG. 5, the frame may be assembled by inserting the protruding portions 325, 323 of the top plate 324 and the protruding portions 327-333 of the side plates 316, 320 into the openings 311, 315-321 in the front 308 and back 312 plates. Some or all of the plates 308, 312, 316, 320, 324 of the frame assembly 304 may be held together by an adhesive. Alternatively, or in addition, the frame assembly 304 may be held together by a screw 328 and an associated nut 332. In one embodiment, the front 308 and back 312 plates may define a hole 309 configured to receive the screw 328. The screw 328 may further be inserted through a sleeve 336 defining a bore 335 configured to receive the screw 328 therethrough. The sleeve 336 may function as a spacer to maintain a desired distance between the front 308 and back 312 plates. Additionally, the sleeve 336 may include a catalytic material or compound such as zinc or copper. The nut 332 may be configured to allow a user to easily disengage the nut from the screw 328. For example, the nut 332 may be a wing nut or the like. Where a sleeve 336 formed from a catalytic material is used, the level of the water 236 (as shown in FIG. 2) should be such that the sleeve 336 is partially or fully submerged during use of the ionizer unit 104. A hanger 340 may be provided for suspending the ionizer unit 104 and the frame assembly 304 from an edge of the basin 112 (as shown in FIG. 1).

As described above, the frame assembly 304 supports the ionizer unit 104. The ionizer unit 104 may include a first integral plate assembly 344 and a second integral plate assembly 348. The first integral plate assembly 344 generally includes an odd number of substantially parallel plates 352. The second integral plate assembly 348 generally includes an even number of substantially parallel plates 356. The frame assembly 304 holds the first plate assembly 344 in a fixed position with respect to the second plate assembly 348. For example, the frame assembly 304 may hold the plate assemblies 344, 348 such that the plates 352 of the first plate assembly 344 are interleaved with and spaced apart from the plates 356 of the second plate assembly 348. Preferably, a plate 352 of the first plate assembly 344 is interspersed between each adjacent plate 356 of the second plate assembly 348, and the side edges of the plates 352, 356 of the first 344 and second 348 plate assemblies are supported by the side plates 316 of the frame assembly 304.

With reference to FIG. 3, the first 344 and second 348 plate assemblies are shown in a side view. As noted above, the first plate assembly 344 may include an odd number of plates 352, while the second plate assembly 348 may include an even number of plates 356. The plates 352 of the first plate assembly 344 may be electrically interconnected to one another in series by connecting portions 404. Similarly, the plates 356 of the second plate assembly 348 may be electrically interconnected to one another in series by connecting portions 408. The first integral assembly 344 may also include a first terminal portion 412 that electrically interconnects the plates 352 to the first prong 204. Similarly, the second integral plate assembly 348 may include a terminal portion 416 for electrically interconnecting the plates 356 to the second electrical prong 208. The first terminal position 412 may be configured to define the first electrical prong 204, and the second terminal position 416 may be configured to define the second electrical prong 208. The terminal portions 412, 416 are generally formed so that the electrical prongs 204, 208 are above the water when the ionizer unit 104 is in operation.

The top plate 324 of the frame assembly 304 can provide a mounting point to fasten the first 412 and second 416 terminal portions to the top plate 324. For example, as best illustrated in FIG. 3, a portion of the first 412 and second 416 terminal portions can be attached to the top plate 324 via bolts 399 and/or screws, a nut-and-bolt structure, any other type of fastening structure, or any combination thereof. The first 412 and second 416 terminal portions may be bent proximate to the top plate 324 so that when mounted to the top plate 324, the first 412 and second 416 terminal portions are substantially flush against the bottom surface of the top plate 324. In another embodiment, the fasteners used to mount the first 412 and second 416 terminal portions to the top plate 204 may be removable fasteners that allow a user to readily detach the electrical prongs 204, 208 from the top plate 324. The top plate 324 may include two openings 333, 334 that are spaced apart from each other. One opening 333 may receive the first 204 electrical prong, and the other opening 334 may receive the second 208 electrical prong. When the therapeutic ionizer apparatus 102 is fully assembled, the first 204 and second 208 electrical prongs may extend above the top plate 324 and above the water level in a substantially vertical orientation through the openings 333, 334. In other embodiments, the top plate 324 may have a single elongated opening that receives both the first 204 and second 208 electrical prongs. In some embodiments, the first 204 and second 208 electrical prongs may be bent so as to extend through the openings 333, 334 at an acute or obtuse angle relative to the top plate 324. In further embodiments, the first 412 and second 416 terminal portions may not be mounted to the top plate 324, but may be mounted to another portion of the frame assembly 304, such as to the side walls 308, 312, or may not be mounted to the frame assembly 304.

The first 204 and second 208 electrical prongs are received by respective first 220 and second 222 female electrical receptacles, which are connected to the control unit 108 (as shown in FIGS. 1 and 2) via first 202 and second 224 electrical conductors. The female electrical receptacles 220, 222 may include an insulating outer layer made from an insulating material, such as rubber or plastic, that covers the conducting portion of the electrical receptacles 220, 222, thereby allowing the user to attach the female electrical receptacles 220, 222 to their corresponding electrical prongs 204, 208 after the control unit 108 is plugged in.

The female electrical receptacles 220, 222 are configured to maintain contact between the conducting portions of the receptacles 220, 222 and the electrical prongs 204, 208 when the ionizer unit 104 is in use. For example, the female electrical receptacles 220, 222 may be sized and shaped so as to fit closely around the electrical prongs 204, 208 to reduce the possibility of the electrical receptacles 220, 222 sliding off the electrical prongs 204, 208 if, for example, the electrical conductors 202, 224 are jostled. The first 220 and second 222 female receptacles and/or the exposed portions of the first 202 and second 224 electrical conductors may be color-coded and/or labeled to make it easier for a user to plug each electrical prong 204, 208 into a proper corresponding electrical receptacle 220, 222. Similarly, in other embodiments, the first 204 and second 208 electrical prongs and the first 220 and second 222 female electrical receptacles may have different configurations, such as different shapes, lengths, widths, and/or thicknesses so that the first electrical prong 204, the second electrical prong 204, or both, fit only their respective female electrical receptacles 220, 222.

The first 204 and second 208 electrical prongs generally extend an appropriate distance above the top plate 324 to allow the electrical receptacles 212, 222 to substantially engage their respective prongs. Such engagement helps to reduce the likelihood of the electrical receptacles 220, 222 sliding off the electrical prongs 204, 208. For example, the electrical prongs 204, 208 may extend least one-third of an inch above the top surface of the top plate 324. In another embodiment, the electrical prongs 204, 208 extend at least a half-inch above the top surface of the top plate 324. The foregoing examples are merely illustrative and are not intended to imply or require that the prongs extend a specific distance above the top plate 324. The prongs may extend any distance above the top plate that allows for substantial engagement between the prongs and the electrical receptacles.

To replace the ionizer unit 104, the ionizer unit 104 may be detached from the frame assembly 304 by removing the nut 332 from the screw 328 connecting the front 308 and back 312 plates of the frame assembly 304. In one embodiment, the frame assembly 304 may be at least partially disassembled by disconnecting the front 308, back 312, and side plates 316, 320 from the ionizer unit 104, which may remain attached to the top plate 324. In some embodiments, the plate assemblies 344, 348 may also be fastened, either by adhesive, rubber bands and/or any known fastening mechanism, to the side plates 316, 320, and the front 308 and back 312 plates may be disconnected from the side plates 316 and the top plate 324 of the ionizer unit 104. Such a fastening system may help reduce the potential for a user to misplace or lose portions of the frame assembly 304 when disassembling and reassembling the frame assembly 304. As such, the user may choose to discard and replace the ionizer unit 104 by itself or the ionizer unit and the top 324 and/or side 316, 320 plates of the frame assembly 304.

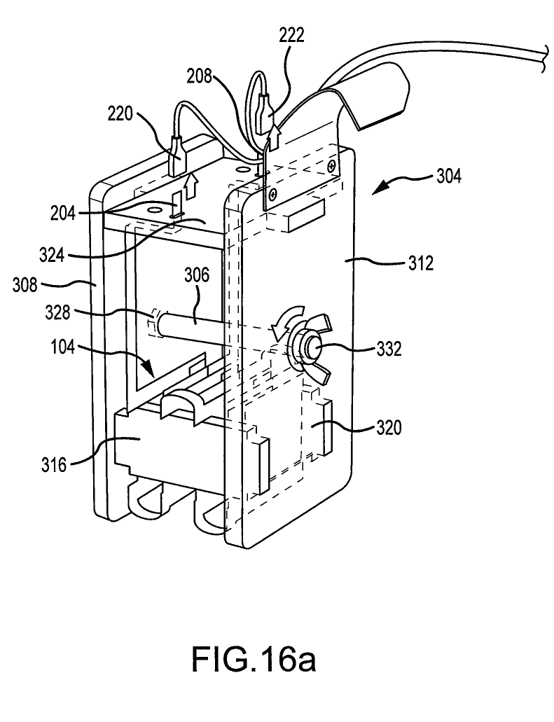

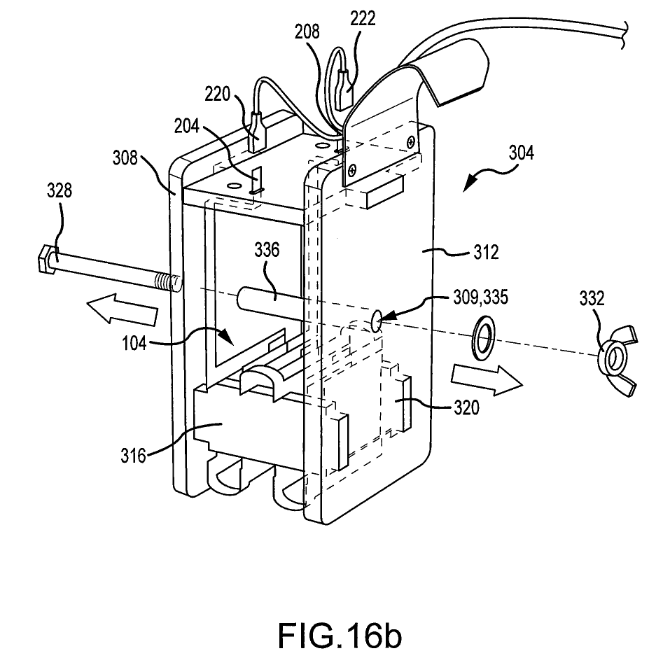

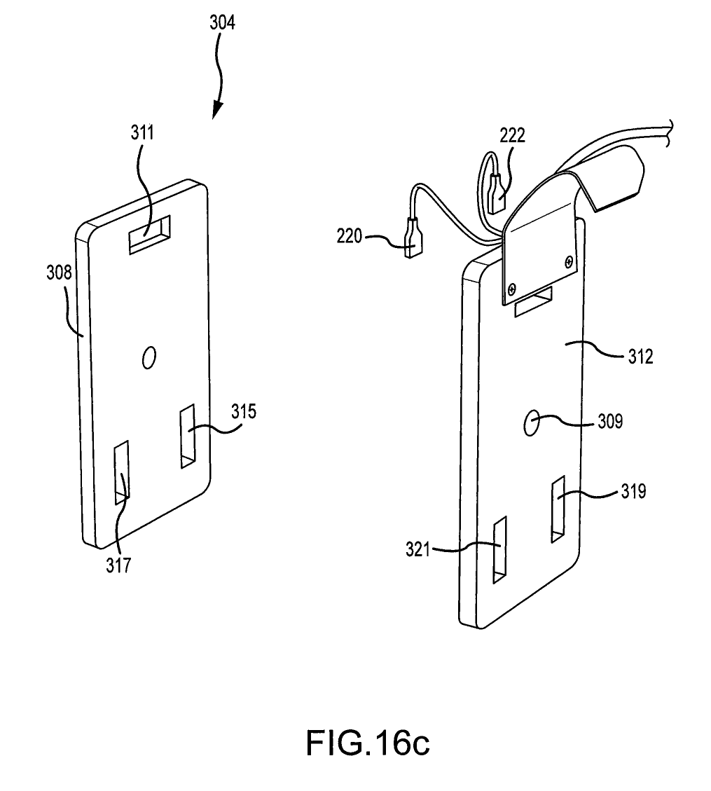

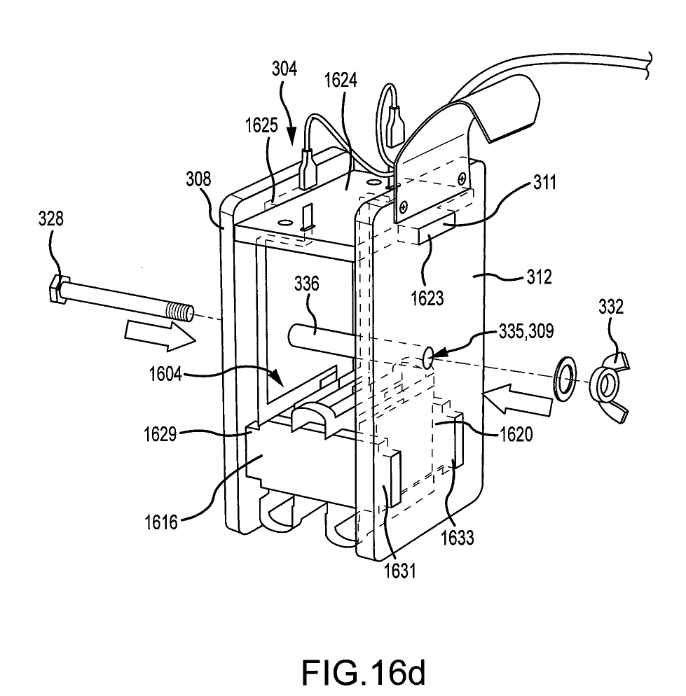

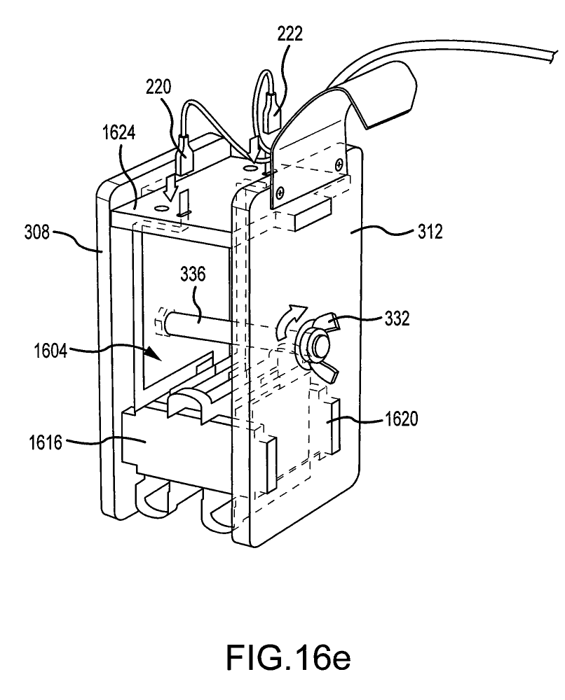

One embodiment for replacing an ionizer unit 104 is shown in FIGS. 16a-16e. FIGS. 16a-16c illustrate the operations for detaching an ionizer unit 104 designated for replacement from the frame assembly 304. As shown in FIG. 16a, the female electrical receptacles 220, 222 may be removed from the terminal ends of the male electrical prongs 204, 208 to disconnect the ionizer unit 104 from the control unit 108 (shown in FIG. 1). In addition, the nut 332 may be rotated to loosen the nut 332 from the screw 328 connecting the front 308 and back 312 plates of the frame assembly 304. As shown in FIG. 16b, the nut 332 may then be removed from the end of the screw 328, and the screw may be withdrawn from the holes 309 defined in the front 308 and back 312 plates, as well as from the bore 305 defined by the sleeve 336 separating the front 308 and back 312 plates. The front 308 and back 312 plates of the frame assembly 304 may then be pulled away from the top 324 and side 316, 320 plates of the frame assembly 304 to disconnect the ionizer unit 104, top 324, and side 316, 320 plates from the front 308 and back 312 plates. FIG. 16c shows the frame assembly 304 with the ionizer unit 104 and the top 324 and side 316, 320 plates removed.

FIGS. 16d and 16e illustrate the operations for connecting a replacement ionizer unit 1604 to the frame assembly 304. The replacement ionizer unit 1604 may include first 1644 and second 1648 plate assemblies connected to new side 1615, 1620 and top 1624 plates. As shown in FIG. 16d, the side 1616, 1620 and top 1624 plates of the replacement ionizer unit 1604 may be connected to the front 308 and back 312 plates of the frame assembly 304 by inserting the protruding portions 1625, 1623 of the top plate 1624 into respective openings 311 located on the front 308 and back 312 plates, and the protruding portions 1627-1633 of the side plates 1616, 1620 into respective openings 315-321 located on the front 308 and back 312 plates. Once the side 1616, 1620 and top 1624 plates of the replacement ionizer unit 1604 are connected to the front 308 and back 312 plates of the frame assembly 304, the sleeve 336 may be positioned between the front 308 and back 312 plates such that the bore 335 defined by the sleeve 336 is axially aligned with the holes 309 for receiving the screw 328 defined in the front 308 and back 312 plates. As shown in FIGS. 16d and 16e, the screw 328 may then be inserted through the front 308 and back 312 plates and the nut 332 may be attached to the end of the screw 328 and tightened to hold the plates 1624, 308, 312, 1616, 1620 together.

As discussed above, if a user is replacing both the top plate 324 and an attached ionizer unit 104 with a new top plate 1624 and an attached replacement ionizer unit 1604, the user may connect the front 308 and back 312 plates of the frame assembly 304 to the new top plate 1624 and the attached replacement ionizer unit 104. Alternatively, if a user is only replacing the ionizer unit 104, the user may attach a replacement ionizer unit 104 to the original top plate 324, which can then be connected to the front 308 and back 312 plates of the frame assembly 304. For example, the frame assembly 304 may be assembled by inserting protruding portions 325, 323 of the original top plate 324 into respective openings 311 located on the front 308 and back 312 plates, and may connect the new side plates 1616, 1620 by inserting the protruding portions 1627-1633 of the side plates 1616, 1620 into respective openings 315-321 located on the front 308 and back 312 plates. Once the plates 324, 308, 312, 1616, 1620 of the frame assembly 304 are connected, the user may insert the screw 328 through the front 308 and back 312 plates and attach the nut 332 to the end of the screw 328 to hold the plates 324, 308, 312, 1616, 1620 together.

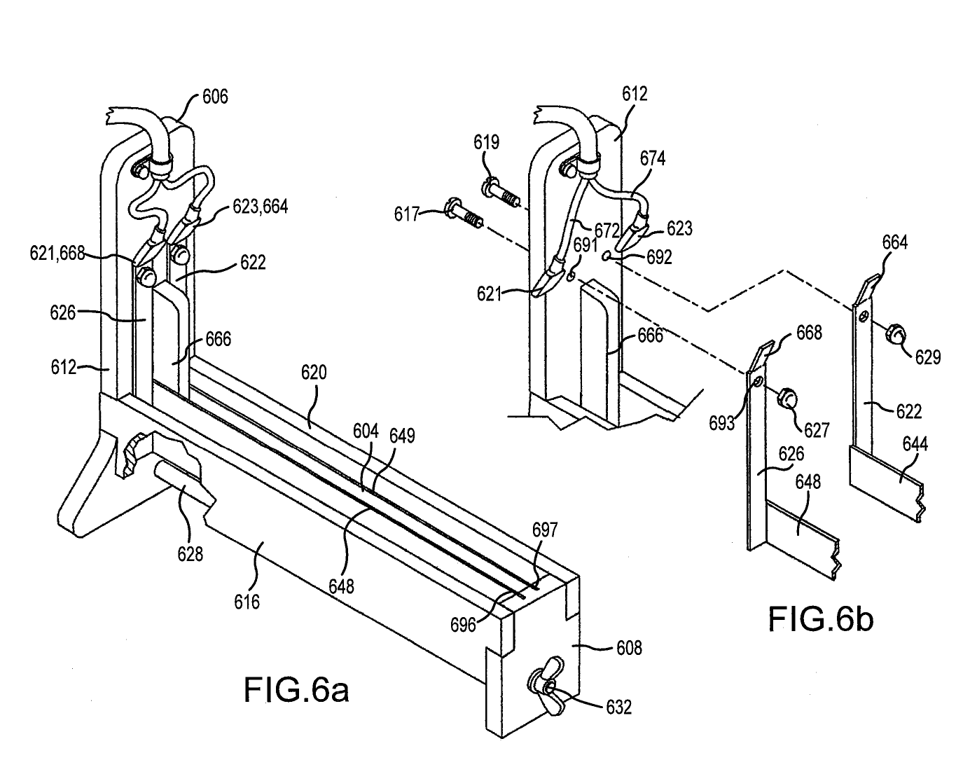

Another embodiment of an ionizer unit 604 is illustrated in FIGS. 6a and 6b. With reference now to FIG. 6a, an ionizer unit 604 is shown in a perspective view. The ionizer unit 604 may be supported by a frame assembly 606 including a front plate 608, a back plate 612, and a pair of side plates 616, 620. The frame assembly 606 may be formed from a non-conductive material such as plastic. The frame assembly 606 may be held together by a rod 628 joining the front 608 and back 612 plates via front and back associated nuts 632. The rod 628 may include a catalytic material or compound, such as zinc, copper or the like. Where a rod 628 formed from a catalytic material is used, the level of the water should be such that the rod 628 is partially or fully submerged during use of the ionizer unit. In other embodiments, the frame assembly 606 may be held together by a screw and nut using an attachment structure similar to that previously described with respect to the embodiment illustrated in FIGS. 1 and 3-5.

The frame 606 supports an ionizer unit 604, which may include a first plate 644 and a second plate 648. The first 644 and second 648 plates may be substantially parallel to one another. The back plate 612 of the frame assembly 606 may further include a protruding portion 666 that extends between the first 644 and second 648 plates from the back plate 612 toward the front plate 608. The front plate 608 may include slots 696, 697 configured to receive edge portions of the first 644 and second 648 plates, thereby supporting the plates 644, 648 and holding the first plate 644 in a fixed position with respect to the second plate 648.

With reference now to FIG. 6b, the first plate 644 may include a first terminal portion 622 that electrically interconnects the first plate 644 to a first prong 664. The first terminal portion 622 may be formed by bending the upper portion of the first plate 644. Similarly, the second plate 648 may include a second terminal portion 626 that electrically interconnects the second plate 648 to the second prong 668. The second terminal portion 626 may be formed by bending the upper portion of the second plate 648. The terminal portions 622, 626 are generally formed so that the electrical prongs 664, 668 are above the water when the ionizer unit is in operation.

The first 622 and second 626 terminal portions can be removably fastened to the back plate 612 of the frame assembly 606. For example, as best illustrated in FIG. 6b, the first 622 and second 626 terminal portions can be removably attached to the back plate 612 by inserting bolts 617, 619 through holes 691-694 provided in the back plate 612 and the terminal portions 622, 626 and attaching corresponding nuts 627, 629 to the ends of the bolts 617, 619. The bolts 617, 619 and nuts 627, 629 may be positioned on the frame assembly 626 to remain above the water when the ionizer unit is fully assembled and in operation.

As shown in FIG. 6a, when the ionizer unit is assembled, the first 622 and second 626 terminal portions are substantially flush against the back plate 612, and the first 664 and second 668 prongs are bent at an acute angle relative to the back plate 612 such that the prongs 664, 668 extend away from the back plate 612. For example, the prongs 664, 668 may be bent so as to define an angle of between 0-45 degrees with respect to the back plate 612. In other embodiments, the prongs 664, 668 may be bent so as to define an angle of between 45-90 degrees with respect to the back plate 612. The foregoing examples are merely illustrative and are not intended to imply or require that the prongs are bent so as to define a specific angle with respect to the back plate 612. The first 664 and second 668 electrical prongs may be received within respective first 621 and second 623 female electrical receptacles, which are connected to a control unit (not shown) via first 672 and second 674 electrical conductors. The female electrical receptacles 621, 623 may include an insulating outer layer made from an insulating material, such as rubber or plastic, that covers the conducting portion of the electrical receptacles 621, 623, thereby allowing the user to attach the female electrical receptacles 621, 623 to their corresponding electrical prongs 664, 668 after the control unit is plugged in. The female electrical receptacles 621, 623 may be configured so as to maintain contact between the conducting portions of the female electrical receptacles 621, 623 and the electrical prongs 664, 668 when the ionizer unit is in use. For example, the female electrical receptacles 621, 623 may be sized and shaped to fit closely around the electrical prongs 664, 668. The first 621 and second 623 female receptacles and/or the exposed portions of the first 664 and second 668 electrical conductors may be color-coded, labeled, and/or shaped to assist a user with plugging each electrical prong 664, 668 into a proper corresponding electrical receptacle 621, 623.

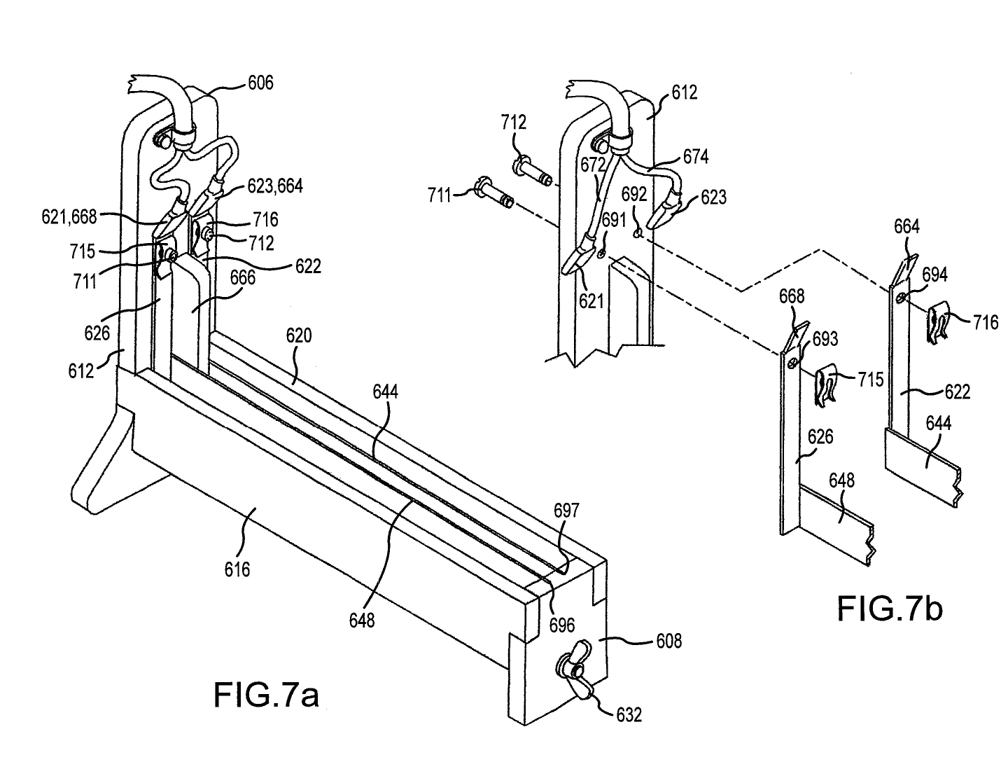

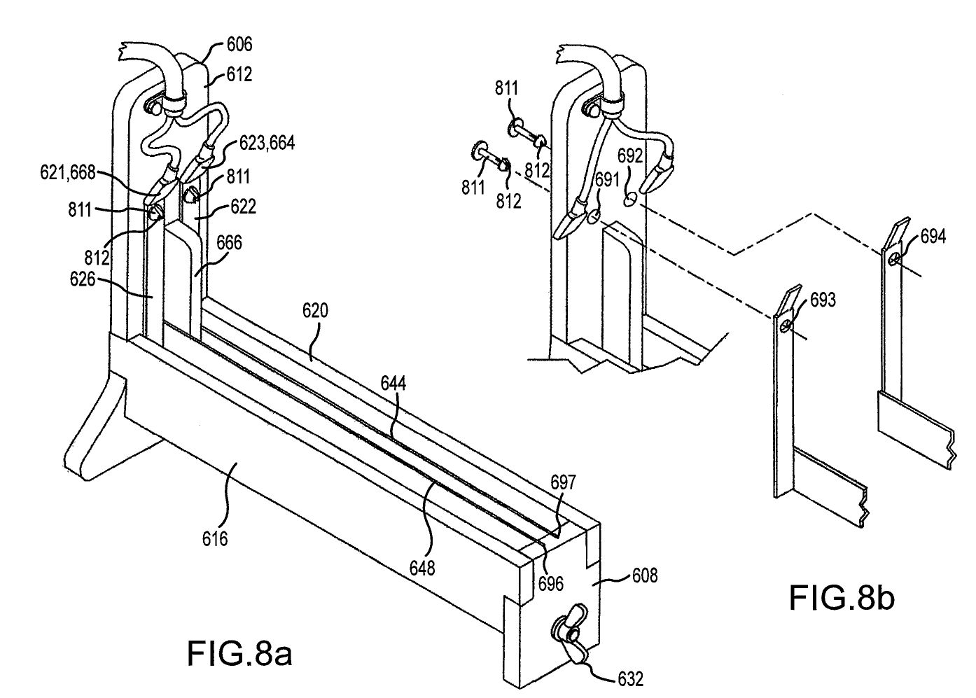

Other attachment mechanisms for removably mounting the plate assembly to the frame shown in FIGS. 6a and 6b are illustrated in FIGS. 7-13. With reference to FIGS. 7a and 7b, the first 622 and second 626 terminals can be mounted to the back plate 612 via bolts 711, 712 that are inserted through the holes 691-694 provided in the back plate 612 and the terminals 622, 626 and received by respective snap fasteners 715, 716, which are configured to snap onto the end portions of the bolts 711, 712. In another embodiment, shown in FIGS. 8a and 8b, the first 622 and second 626 terminals can be mounted to the back plate 612 via snap-lock nails 811 that are inserted through holes 691-694 provided in the back plate 612 and the terminals 622, 626. The snap-lock nails 811 may include a slot along the nail head portion 812 of the nail 811 to allow the nail head portion 812 to constrict when inserted into the holes 691-694 in the back plate 612 and the terminals 622, 626 and to naturally expand to lock the back plate 612 and the terminals 622, 626 in place once the nail head portion 812 is received through the holes 691-694. The snap-lock nails 811 may be formed from a resilient material, such as metal, rubber, plastic or foam that allows the nails 811 to constrict and then resiliently expand to their natural uncompressed shape.

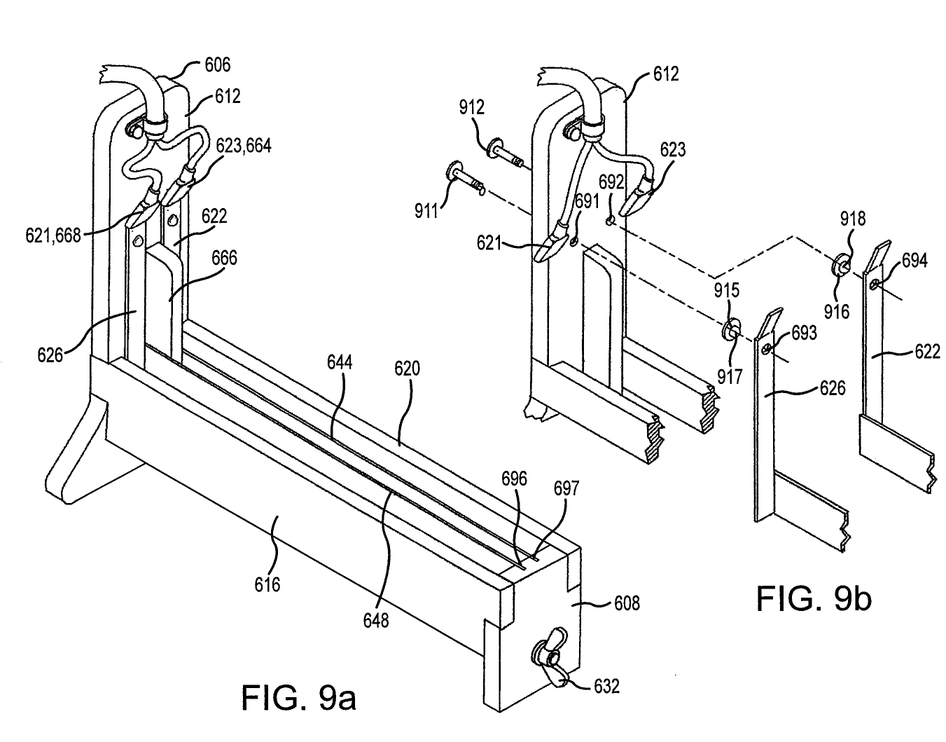

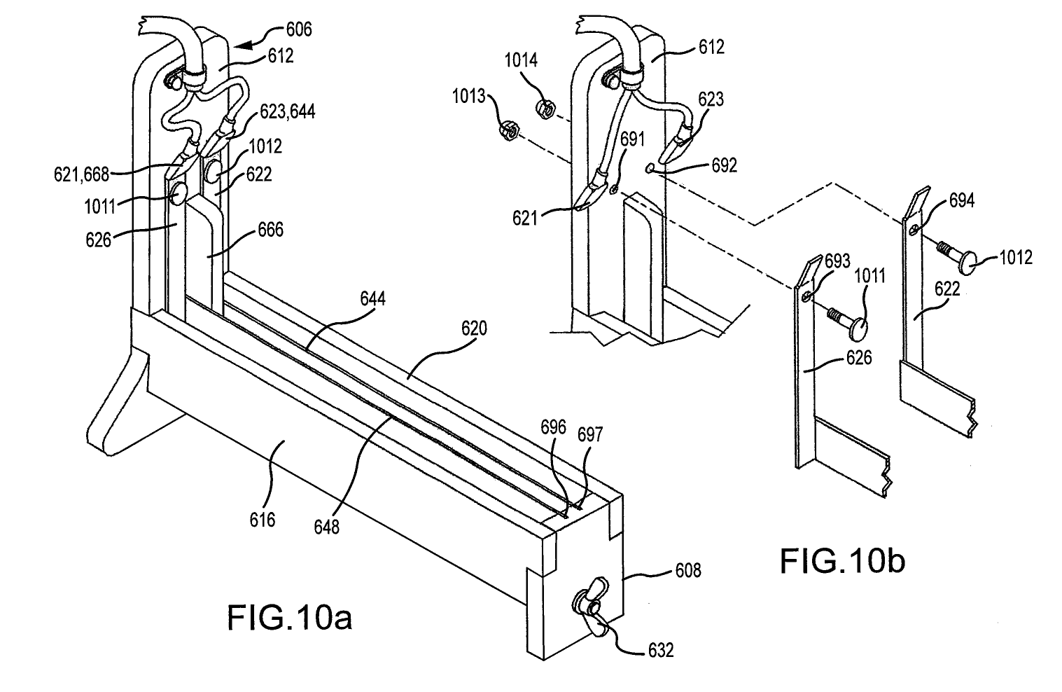

With reference to FIGS. 9a and 9b, the first 622 and second 626 terminals can be mounted to the back plate 612 via bolts 911, 912 that are inserted through holes 691, 692 provided in the back plate 612 and received by respective caps 915, 916 positioned between the front-facing side of the back plate 612 and the back-facing side of the terminals 622, 626. The front-facing side of the caps 915, 916 may include raised portions 917, 918 configured to snap into the holes 693, 694 in the first 622 and second 626 terminals to lock the terminals 622, 626 into place. The caps 915, 916 may be formed from a resilient material, such as plastic, rubber, foam, or any other resilient material that allows the front-facing side of the caps 915, 916 to constrict and expand once inserted into the holes 693, 694 in the terminals 622, 626. As shown in FIGS. 10a and 10b, the first 622 and second 626 terminals can alternatively be mounted to the back plate 612 via bolts 1011, 1012 that are inserted through the holes 691-694 in the terminals 622, 626 and the back plate 612 and received by respective nuts 1013, 1014 that are screwed onto the end portions of the bolts 1011, 1012.

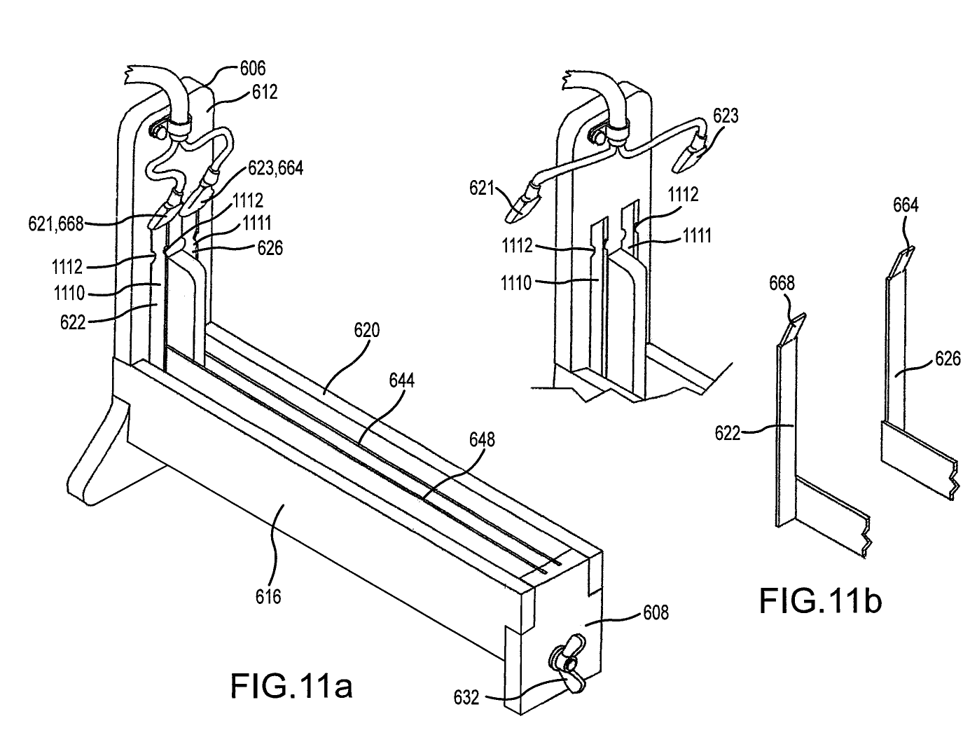

Another embodiment of the present invention is illustrated in FIGS. 11a and 11b, in which the back plate 612 is manufactured to form grooves 1110, 1111 that are configured to receive and hold the terminals 622, 626. The terminals 622, 626 may be received in the grooves by sliding them into the grooves 1110, 1111. The grooves 1110, 1111 may each include one or more retaining tabs 1112 extending from the edges of the grooves 1110, 1111 to retain the terminals 622, 626 in the grooves 1110, 1111.

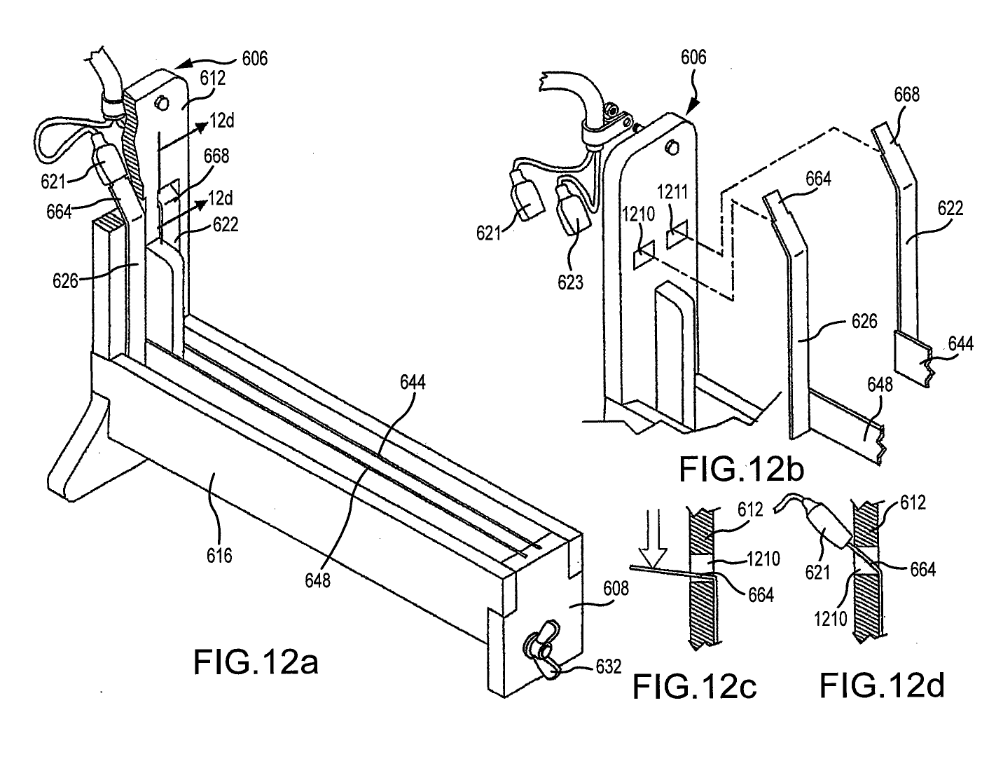

A further embodiment of the present invention is illustrated in FIGS. 12a to 12d, in which the back plate 612 includes openings 1210, 1211 configured to receive a portion of the terminals 622, 626, which are rearwardly bent 612 toward the back plate 612. As shown, for example, in FIG. 12c, the terminals 622, 626 may be inserted through the openings 1210, 1211 by further bending or compressing the terminals 622, 626 into lowered position. Once the prongs 664, 668 are inserted through the openings 1210, 1211, the terminals 622, 626 may be released so as to return toward their original shape. As shown in FIG. 12d, in this released position, the terminals 622, 626 may engage the areas of the back plate 612 defining the openings 1210, 1211, thus helping to retain the terminals 622, 626 against the back plate 612. As shown in FIG. 12a, the electrical prongs 664, 668 may extend an appropriate distance from the back plate 612 so as to limit the potential for the female receptacles 621, 623 from sliding off the prongs 664, 668.

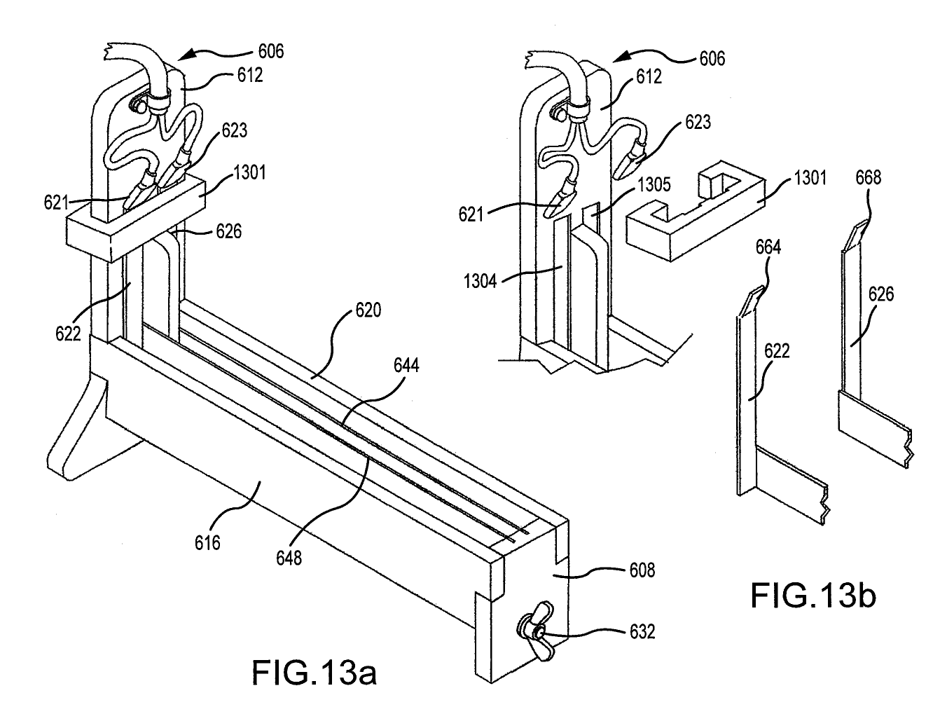

FIGS. 13a and 13b illustrate another embodiment of the present invention, which includes a slidable bracket 1301 configured to slide along the back plate 612. The bracket 1301 includes two slots 1302, 1303 that are configured to slide over the prongs 664, 668 of the electrical terminals 622, 626 to secure the terminals 622, 626 to the back plate 612. As shown in FIG. 13b, the back plate 612 may include two recessed areas or grooves 1304, 1305 configured to receive the terminals 622, 626. In this example, a user may remove the first 644 and second 648 plates by sliding the bracket 1301 over and above the electrical prongs 664, 668. Once moved to this position, the plates may be removed from the frame assembly. New plates may then be joined to the frame assembly, and the bracket 1301 can be slid back to a position such that it is positioned over the new plates.

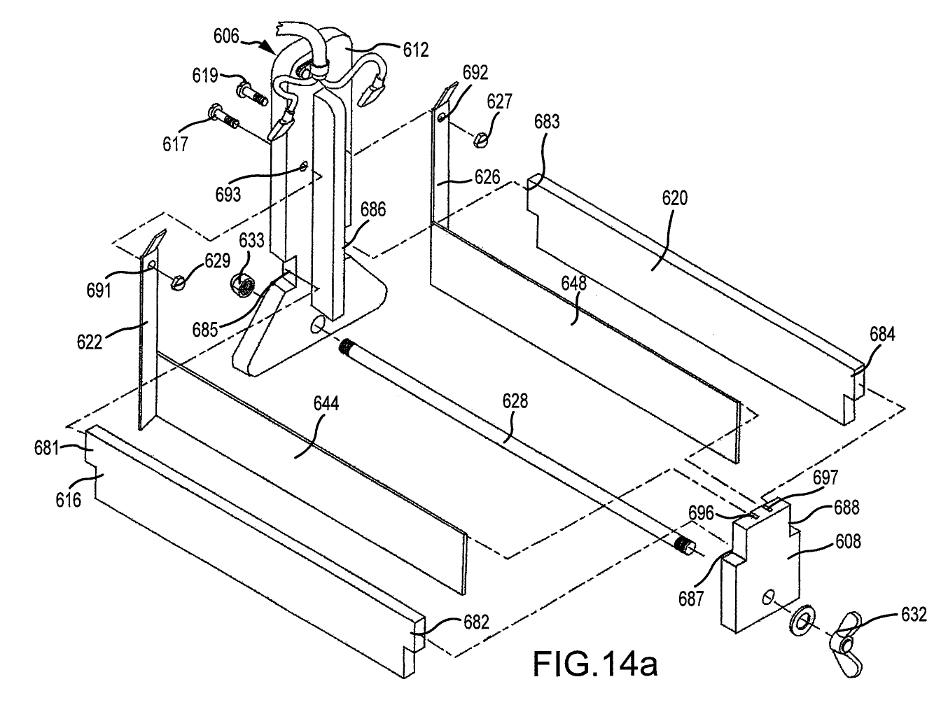

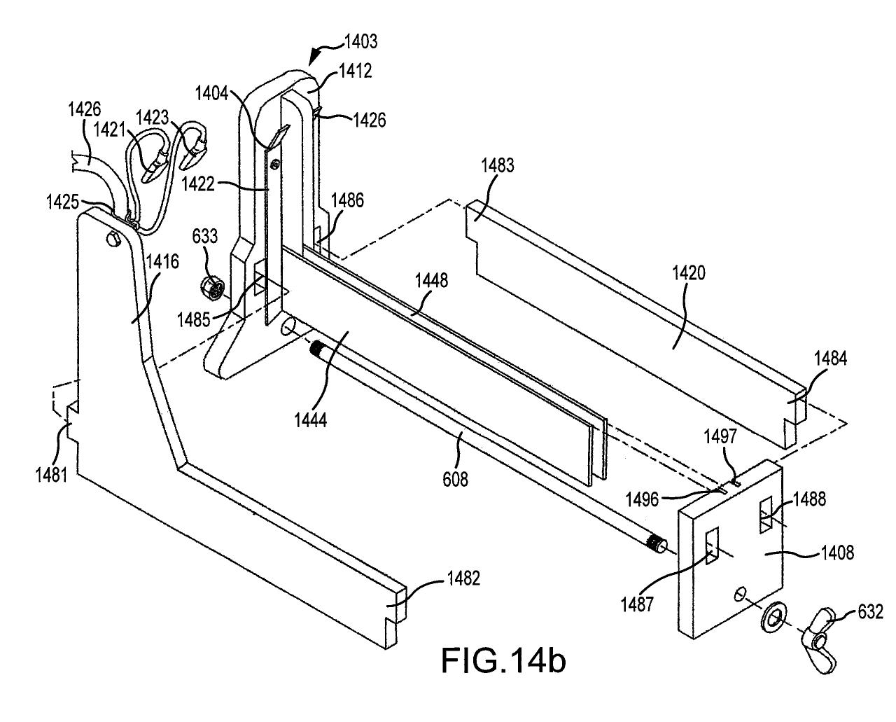

FIG. 14a illustrates an exploded perspective view of the embodiment of the ionizer unit 604 and the frame 606 shown in FIGS. 6a and 6b. To remove the ionizer unit 604 from the frame 606, a user may first unscrew nuts 632, 633 from the end of the rod 628 to detach the front plate 608 of the frame assembly from the side plates 616, 620 and the first 644 and second 648 plates of the ionizer unit 604, and the side plates 616, 620 from the back plate 612. The user may then detach the first 644 and second 648 plates from the back plate 612 by unscrewing nuts 627, 629 from bolts 617, 619, and removing the bolts 617, 619 from the holes 691-694 provided in the first 622 and second 626 terminals and the back plate 612.

To replace the ionizer unit 604, a user may first attach new first 644 and second 648 plates to the back plate 612 by inserting bolts 618, 619 through holes 691, 694 in the terminals 622, 626 and the back plate 612, and attaching nuts 626, 629 to the ends of the bolts 618, 619. Once the terminals 622, 626 of the new plates 644, 648 are attached to the back plate 612 of the frame assembly 606, the user may attach the side plates 616, 620 to the back plate 612 by inserting protruding portions 681, 683 of the side plates into receiving slots 685-686 on the back plate 612. The front plate 608 may be attached to the side plates 616, 620 and the ionizer plates 644, 648 by inserting protruding portions 682, 684 of the side plates into receiving slots 685, 686 on the front plate 608, and inserting the edge portions of the ionizer plates 644, 648 into receiving slots 696, 697 on the front plate 608. The plates 616, 620, 608, 612 of the frame assembly 606 may then be secured together by inserting the rod 628 through the front 608 and back 612 plates and attaching nuts 633, 632 to the end of the rod 608.

FIG. 14b illustrates an exploded perspective view of another embodiment of the ionizer unit 1401 and supporting frame 1403. In this embodiment, the first 1422 and second 1426 terminals may be more permanently secured to the back plate 1412 of the frame 1403 by rivets, adhesive, welding, or any other known fastening means. In contrast with the embodiment illustrated in FIG. 14a, the mounting point 1425 for the connection 1426 to the control unit (shown in FIG. 1) is located on the side plate 1416, rather than on the back plate 1412. To remove the ionizer unit 1404, a user may first unscrew nuts 632, 633 from the end of the rod 628 to detach the front plate 1408 of the frame assembly from the side plates 1416, 1420 and the first 1444 and second 1448 plates of the ionizer unit 1404, and the side plates 1416, 1420 from the back plate 1412. The user may then remove and discard the back plate 1412 and attached ionizer plates 1444, 1448.

To replace the ionizer unit 1404, a user may attach the side plates 1416, 1420 to a new back plate 1412, which is attached to replacement ionizer plates 1444, 1448, by inserting protruding portions 1481, 1483 of the side plates into openings 1485-1486 on the new back plate 612 configured to receive the protruding portions 1481, 1483. The front plate 1408 may then be attached to the side plates 1416, 1420 and the ionizer plates 1444, 1448 by inserting protruding portions 682, 684 of the side plates into respective openings 685, 686 on the front plate 608 and the edge portions of the ionizer plates 1444, 1448 into slots 1496, 1497 on the front plate 608. The plates 1416, 1420, 1408, 1412 of the frame assembly 1403 may then be secured together by inserting the rod 628 through the front 1408 and back 1412 plates and attaching nuts 633, 632 to the end of the rod 608.

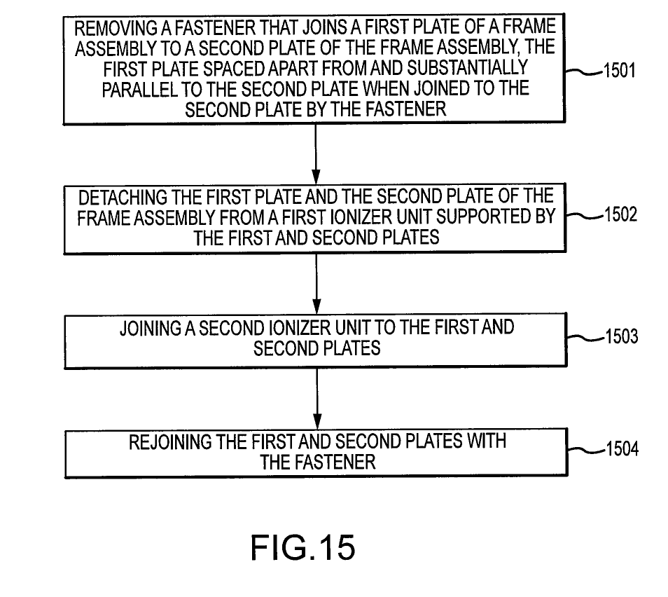

FIG. 15 illustrates a method for replacing an ionizer unit in a therapeutic spa system. As shown in step 1501, a fastener that joins a first plate of a frame assembly to a second plate of the frame assembly is removed. The first plate may be spaced apart from and substantially parallel to the second plate when joined to the second plate by the fastener. In step 1502, the first plate and the second plate of the frame assembly are detached from a first ionizer unit supported by the first and second plates. In step 1503, a second ionizer unit is joined to the first and second plates, and in step 1504, the first and second plates are rejoined with the fastener.

It should be noted that the flowchart of FIG. 15 is illustrative only. Alternative embodiments of the present invention may add operations, omit operations, or change the order of operations without affecting the spirit or scope of the present invention.

All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like.

In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention.

What is claimed is:

1. A method for replacing an ionizer unit of a therapeutic spa system, comprising:
removing a fastener that joins a first plate of a frame assembly to a second plate of the frame assembly, the first plate spaced apart from and substantially parallel to the second plate when joined to the second plate by the fastener;
detaching the first plate and the second plate of the frame assembly from a first ionizer unit supported by the first and second plates;
joining a second ionizer unit to the first and second plates; and
rejoining the first and second plates with the fastener.

2. The method of claim 1, wherein the frame assembly further comprises a third plate configured to be releasably joined to the first and the second plates, the first ionizer unit is joined to the third plate, and the first and second plates of the frame assembly are detached from the third plate before joining the second ionizer unit to the first and second plates.

3. The method of claim 2, wherein the frame assembly further comprises a fourth plate supporting the first ionizer unit, and the first and second plates of the frame assembly are detached from the fourth plate before joining the second ionizer unit to the first and second plates.

4. The method of claim 2, further comprising detaching from the first ionizer unit an electrical connection joining the ionizer unit to a power supply.

5. The method of claim 1, wherein the fastener comprises a nut and a bolt.

6. A therapeutic spa system comprising:
a frame assembly comprising a first plate, a second plate and a third plate, the first plate of the frame assembly releasably secured to the second plate of the frame assembly by a fastener, the first plate spaced apart from the second plate when joined by the fastener and the third plate positioned between the first and second plates;
an ionizer unit including an electrical terminal;
the ionizer unit supported by the frame assembly and positioned between the first and the second plates, at least a portion of the electrical terminal extending through a slot defined in the third plate.

7. The therapeutic spa system of claim 6, wherein the third plate includes portions configured for receipt within respective openings in the first and the second plates.

8. The therapeutic spa system of claim 6, wherein at least a portion of the ionizer unit is secured to the third plate.

9. The therapeutic spa system of claim 8, wherein the frame assembly further comprises a fourth plate releasably secured to and supporting the ionizer unit, the fourth plate including portions configured for insertion into respective openings in the first and second plates.

10. The therapeutic spa system of claim 8, wherein the electrical terminal comprises a prong configured for insertion into an electrical receptacle of a control unit.

11. The therapeutic spa system of claim 6, further comprising a basin configured to hold a fluid and a control unit configured to be coupled to a power source, wherein the ionizer unit is coupled to the control unit.

12. The therapeutic spa system of claim 6, wherein the first plate is substantially parallel to the second plate.

13. The therapeutic spa system of claim 6, wherein the fastener comprises a nut and a bolt.

14. A therapeutic spa system comprising:
an ionizer unit supported by a frame assembly comprising a first plate, a second plate, and a third plate, the first plate spaced apart from the second plate and the third plate extending between the first and second plates, the ionizer unit comprising a first plate assembly formed from conductive material and a second plate assembly formed from conductive material;
the first plate assembly including a first terminal portion and the second plate assembly including a second terminal portion, and the first plate assembly including a portion received within a first slot defined in the first plate of the frame assembly, and the second plate assembly including a portion received within a second slot defined in the first plate of the frame assembly;
the first terminal portion releasably fastened to the second plate of the frame assembly proximate an end portion of the first terminal portion and the second terminal portion releasably fastened to the second plate of the frame assembly proximate an end portion of the second terminal portion; and
said end portion of the first terminal portion extends away from the second plate at an acute angle relative to the second plate.

15. The therapeutic spa system of claim 14, wherein the third plate includes portions configured for receipt within respective openings in the first and second plates of the frame assembly.

16. The therapeutic spa system of claim 15, wherein the frame assembly further comprises a fourth plate including portions configured for receipt within respective openings in the first and second plates of the frame assembly.

17. The therapeutic spa system of claim 14, wherein the end portion of the first terminal portion comprises a prong configured for insertion into an electrical receptacle of a control unit.

18. The therapeutic spa system of claim 17, further comprising a basin configured to hold a fluid, wherein the control unit is configured to be coupled to a power source.

19. The therapeutic spa system of claim 14, wherein the first plate is releasably secured to the second plate so that the first and second plates are substantially parallel to one another.

20. The therapeutic spa system of claim 14, wherein the first plate is releasably secured to the second plate by a nut and a bolt.
